(19) United States
(12) Patent Application Publication
(10) Pub. No.: US 2025/0260068 A1
(43) Pub. Date: Aug. 14, 2025

(54) VEHICLE

(71) Applicant: TOYOTA JIDOSHA KABUSHIKI KAISHA, Toyota-shi (JP)

(72) Inventor: Shinji ICHIKAWA, Nagoya-shi (JP)

(73) Assignee: TOYOTA JIDOSHA KABUSHIKI KAISHA, Toyota-shi (JP)

(21) Appl. No.: 18/969,523

(22) Filed: Dec. 5, 2024

(30) Foreign Application Priority Data
Feb. 14, 2024 (JP) 2024-020157

(51) Int. Cl. H01M 10/42; H01M 10/48; H01M 50/249

(52) U.S. Cl. CPC H01M 10/4228; H01M 10/48; H01M 50/249; H01M 2220/20

(57) ABSTRACT

ECU performs a process including the steps of acquiring a resistance value of an insulation resistance, determining that a resistance value is equal to or less than a threshold value, determining that an electric leakage occurs on the vehicle body side, turning on a SMR when the resistance value is greater than the threshold value, acquiring a resistance value of the insulation resistance, determining that an electric leakage occurs on the battery pack side when the resistance value is equal to or less than the threshold value, and determining that there is no electric leakage when the resistance value is greater than the threshold value.

### CROSS-REFERENCE TO RELATED APPLICATION

This application claims priority to Japanese Patent Application No. 2024-020157 filed on Feb. 14, 2024, incorporated herein by reference in its entirety.

### BACKGROUND

### 1. Technical Field

The present disclosure relates to a vehicle including a detachable battery.

### 2. Description of Related Art

Japanese Unexamined Patent Application Publication No. 2021-189122 (JP 2021-189122 A) discloses an electric leakage detection device that calculates an insulation resistance for each path of an electric circuit provided in an electrified vehicle and identifies a path having an electric leakage based on the calculated value.

### SUMMARY

In the above electric leakage detection device, however, a vehicle including a detachable battery is not assumed. Therefore, electric leakage detection according to the attached or detached state of the battery is not assumed. There is a possibility that appropriate electric leakage detection cannot be performed.

The present disclosure has been made to solve the above problem, and an object thereof is to provide a vehicle that includes a detachable battery and performs appropriate electric leakage detection.

A vehicle according to an aspect of the present disclosure includes:
a vehicle body;
a battery detachable from the vehicle body; and
a detection device provided to an electric circuit on the vehicle body side and configured to detect whether an electric leakage has occurred. The detection device is configured to detect whether the electric leakage has occurred in at least one of a conductive state in which the battery and the electric circuit are connected and a disconnected state in which the battery and the electric circuit are disconnected.

In this way, whether the electric leakage has occurred is detected when the battery and the electric circuit on the vehicle body side are in the conductive state or the disconnected state. Accordingly, it is possible to accurately determine whether the electric leakage is caused by the electric circuit on the vehicle body side or by the battery.

In one embodiment, the detection device may be configured to detect whether the electric leakage of the electric circuit has occurred in the disconnected state and, when the electric leakage is not detected, detect whether the electric leakage has occurred in the conductive state.

In this way, whether the electric leakage of the electric circuit on the vehicle body side has occurred can be detected in the disconnected state. When the electric leakage of the electric circuit on the vehicle body side is not detected, whether the electric leakage of the battery has occurred can be detected in the conductive state.

In a further embodiment, the vehicle body may be configured such that a plurality of the batteries is mountable. Each of the batteries may include a relay configured to connect or disconnect the electric circuit.

The detection device may be configured to change a combination of an ON state and an OFF state of the relays of the batteries and detect whether the electric leakage has occurred in each of the batteries.

In this way, in the vehicle including the plurality of batteries, the combination of the ON state and the OFF state of the relays is changed and whether the electric leakage has occurred in each of the batteries is detected. Thus, it is possible to determine which battery has the electric leakage.

In a further embodiment,

the vehicle may further include a notification device. The notification device may be configured to give a notification about occurrence of the electric leakage in the vehicle body when the detection device has detected the electric leakage of the electric circuit in the disconnected state.

In this way, the user can recognize that the electric leakage is caused by the electric circuit on the vehicle body side.

In a further embodiment, the vehicle may further include a notification device. The notification device may be configured to give a notification about occurrence of the electric leakage in the battery when the detection device has not detected the electric leakage of the electric circuit in the disconnected state and has detected the electric leakage of the electric circuit in the conductive state.

In this way, the user can recognize that the electric leakage is caused by the battery.

According to the present disclosure, it is possible to provide the vehicle that includes the detachable battery and performs appropriate electric leakage detection.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle according to the present embodiment;

FIG. 2 is a diagram illustrating an example of a configuration of a battery replacement system for replacing a battery pack;

FIG. 3 is a flowchart illustrating an example of a method of replacing a battery pack;

FIG. 4 is a flowchart illustrating an example of the electric leakage determination process of FIG. 3;

FIG. 5 is a diagram illustrating an example of a configuration of vehicles according to a modification; and

FIG. 6 is a flowchart illustrating an example of the electric leakage determination process according to the modification.

### DETAILED DESCRIPTION OF EMBODIMENTS

Hereinafter, an embodiment of the present disclosure will be described in detail with reference to the drawings. It should be noted that the same or corresponding parts in the drawings are designated by the same reference characters and repetitive description will be omitted.

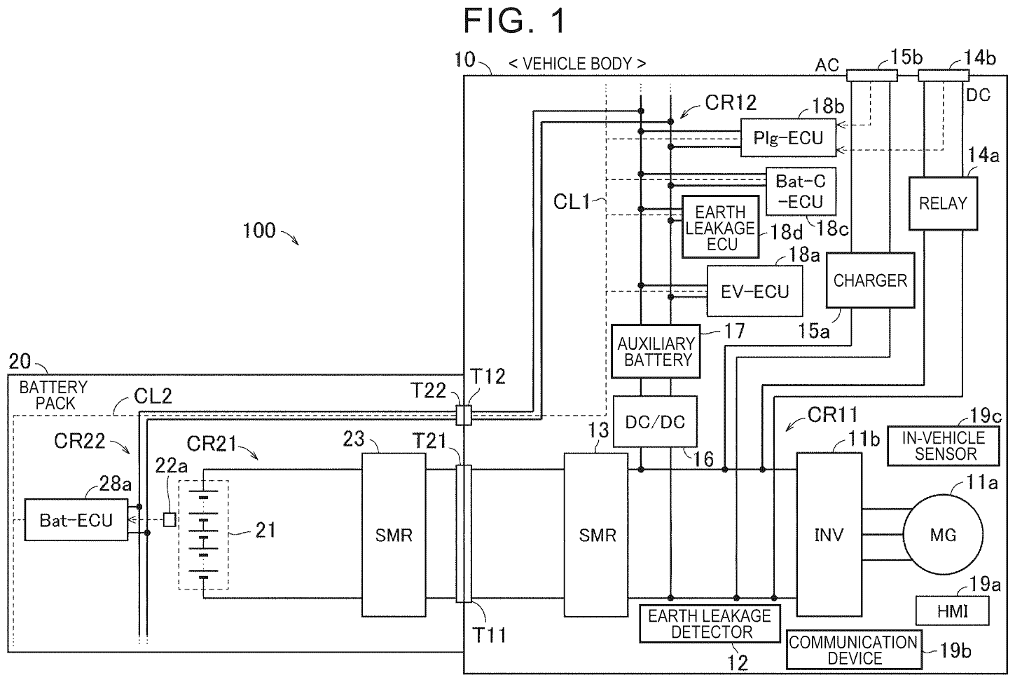

FIG. 1 is a diagram illustrating an example of a configuration of a vehicle according to the present embodiment. Referring to FIG. 1, a vehicle 100 includes a vehicle body 10 and a battery pack 20. The vehicle body 10 is a portion of the vehicle 100 other than the battery pack 20. The vehicle body 10 includes a vehicle driving device serving as a driving source. Vehicle-driven devices include MG (Motor Generator) 11a and inverters 11b.

The vehicle driving device is configured to drive the vehicle 100 using the electric power output from the battery pack 20. The battery-pack 20 is configured to be connectable to an inverter 11b. The vehicles 100 are, for example, battery electric vehicle that do not include an internal combustion engine. However, the present disclosure is not limited thereto, and the vehicles 100 may be plug-in hybrid electric vehicle including an internal combustion engine or other electrified vehicle.

The vehicle body 10 includes a circuit CR11 and a CR12. The battery-pack 20 includes a circuit CR21 and a CR22. The circuit CR12 includes an auxiliary battery 17. The circuit CR21 includes a battery 21. The battery 21 is, for example, a secondary battery such as a lithium ion battery, a nickel metal hydride battery, or a sodium ion battery. The type of the secondary battery may be a liquid secondary battery or an all-solid secondary battery. A plurality of secondary batteries may form a battery pack. The auxiliary battery 17 corresponds to a low-voltage power supply that outputs power at a voltage lower than the voltage of the battery 21. A DC/DC converter 16 is provided between the circuit CR11 and the circuit CR12.

The circuit CR11 in the vehicle body 10 includes a MG 11a, an inverter 11b, a DC charge relay 14a, a DC inlet 14b, a AC charger 15a, and a AC inlet 15b. Further, the circuit CR11 is provided with a leakage detector 12. A BMS (Battery Management System) 22a is provided in a circuit CR21 in the battery pack 20.

The vehicle body 10 further includes a terminal T11 to which the battery pack 20 can be attached and a SMR (System Main Relay) 13 disposed between the terminal T11 and the vehicle driving device (inverter 11b). The circuit CR11 (high-voltage power supply line) is connected to the terminal T11 via a SMR 13. The battery-pack 20 includes a terminal T21 to which the vehicle body 10 is attachable and detachable, and a SMR 23 disposed between the terminal T21 and the circuit CR21. The circuit CR21 (high-voltage power supply line) is connected to the terminal T21 via a SMR 23.

The terminal T21 of the battery pack 20 is connected to the terminal T11 of the vehicle body 10. SMR 23 of the battery pack 20 is disposed between the terminal T21 of the battery pack 20 and the battery 21. SMR 23 enables the connection/disconnection between the target device (inverter 11b) and the battery 21 to be easily and appropriately switched.

The vehicle body 10 further includes a terminal T12 to which the battery

10 pack 20 can be attached and detached. Circuit CR12 (low-voltage power supply line) in the vehicle body 10 is connected to the terminal T12. A communication line CL1 (a broken line in FIG. 1) in the vehicle body 10 is also connected to the terminal T12. The battery-pack 20 further includes a terminal T22. In the battery-pack 20, the circuit CR22 (low-voltage power supply line) and the communication line CL2 (broken line in FIG. 1) are connected to the terminal T22. 15

The auxiliary battery 17 supplies electric power for driving auxiliary machines mounted on the vehicle 100. The auxiliary battery 17 outputs DC power to the circuit CR12 (low-voltage power supply line). The circuit CR12 further includes an ECU 18a, 18b, 18c, 18d in addition to the auxiliary battery 17. The circuit CR22 further includes an ECU 28a. The auxiliary battery 17 supplies power to each of 18d, 28a from, for example, an ECU 18a connected to the low-voltage power supply line. “ECU” means an electronic control unit (Electronic Control Unit).

ECU 18a corresponds to a control device (EV-ECU) that controls various types of control related to the vehicles 100. ECU 18b corresponds to a control device (Plg-ECU) that detects the status of each of DC inlet 14b and AC inlet 15b. ECU 18c corresponds to a control device (Bat-C-ECU) that controls DC charge-relay 14a and AC charger 15a. ECU 18d corresponds to a control device (earth leakage ECU) that monitors the earth leakage status of the circuit CR11. For example, ECU 18d detects a current between the electric circuit including the circuit CR11 and the grounding, calculates a resistance value of the insulation resistance using the detected current, and calculates the calculated resistance value as a leakage condition. ECU 28a corresponds to a control device (Bat-ECU) that monitors the status of the batteries 21 and controls SMR 23.

ECU includes a processor and a storage device. The storage device is configured to be able to save the stored information. In addition to the program, the storage device stores various kinds of information used in the program. In this embodiment, various kinds of control are executed by the processor executing a program stored in the storage device. However, these processes may be executed only by hardware (electronic circuit) without using software.

In the vehicle 100, ECU are communicably connected to each other via an in-vehicle network (e.g., a CAN (Controller Area Network)). ECU 18a obtains information from other ECU, controls the inverter 11b, DC/DC converters 16 and SMR 13, 23, and sends control commands to ECU 18c and ECU 28a.

The leakage detector 12 detects a leakage condition of the circuit CR11 (for example, a resistance of an insulating resistor), and outputs the detection result to ECU 18d. BMS 22a detects the condition (current, voltage, temperature, etc.) of the battery 21, and outputs the detected condition to ECU 28a. ECU 18a acquires information indicating the leakage state and the battery state from ECU 18d, 28a.

DC/DC converters 16 transform DC power between the circuit CR11 and the circuit CR12. Specifically, DC/DC converters 16 step down the DC power from the batteries 21, and provide the DC power to the auxiliary battery 17 and other auxiliary devices connected to the circuit CR12. The capacity of the battery 21 is larger than the capacity of the auxiliary battery 17.

When the terminal T21, T22 of the battery pack 20 is connected to the terminal T11, T12, the battery pack 20 is attached to the vehicle body 10, thereby forming the vehicle 100. In the vehicle 100, the communication line CL1 of the vehicle body 10 and the communication line CL2 of the battery pack 20 are connected. These communication lines constitute an in-vehicle network (e.g., a CAN) of the vehicle 100.

MG 11a functions as a driving motor. The inverter 11b functions as a PCU (Power Control Unit for MG 11a). The inverter 11b drives MG 11a using the electric power supplied from the battery 21 of the battery pack 20. MG 11a converts power to torques and rotates the drive wheels of the vehicles 100. In addition, MG 11a performs regenerative power generation at the time of deceleration of the vehicles 100, for example, and charges the batteries 21.

Each of DC inlet 14b and AC inlet 15b has a terminal for detecting connection/disconnection of the charging cable (plug), and outputs a signal indicating whether or not the charging cable is connected to ECU 18b. ECU 18a acquires information indicating the inlet state from ECU 18b, and transmits a control command to ECU 18c. AC charger 15a performs AC/DC transformation. The plug-in charge of the batteries 21 is executed by cooperation of ECU 18a and 18c.

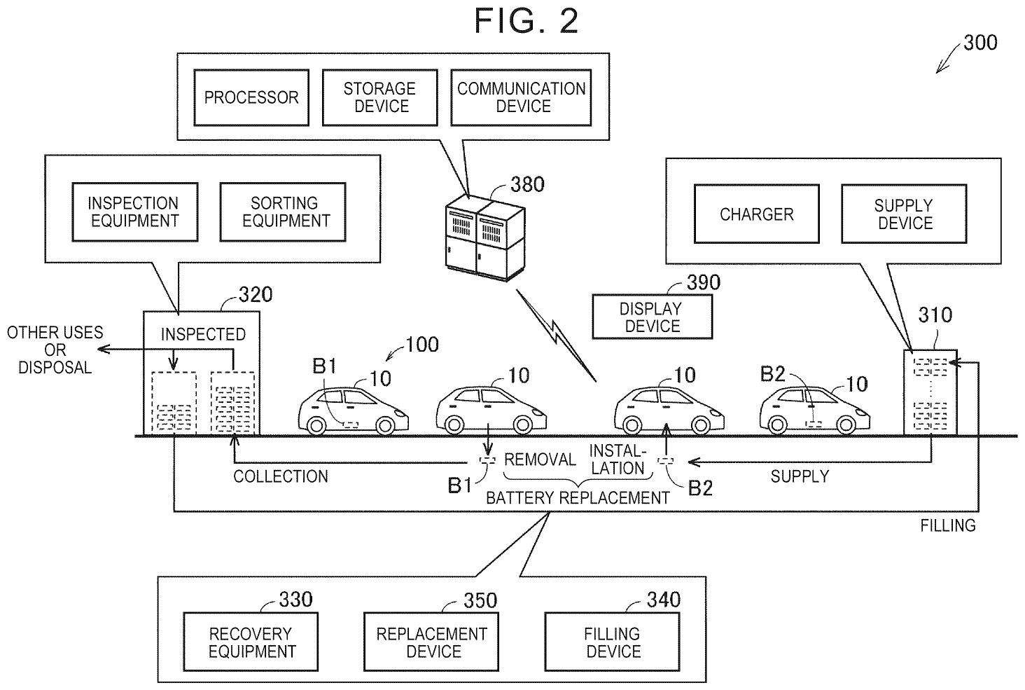

The vehicle body 10 further includes a HMI (Human Machine Interface) 19a and a communication device 19b. HMI 19a and the communication device 19b are also supplied with electric power from the auxiliary battery 17. HMI 19a includes a notification device such as an inputting device and a displaying device provided in the vehicle cabin. HMI 19a may include a touch panel display. The input device outputs a signal corresponding to an input from the user to ECU 18a. The communication device 19b is configured to be capable of wirelessly communicating with the server 380 (FIG. 2) described later. In addition, various sensors (typically referred to as in-vehicle sensor 19c) that are not illustrated are also mounted on the vehicle body 10. ECU 18a is configured to acquire the detections of these sensors, either directly or via other ECU.

In this embodiment, HMI 19a includes an activation switch. The user of the vehicle 100 can activate or deactivate the control system (including ECU) of the vehicle 100 or turn the vehicle 100 Ready-ON or Ready-OFF by operating the activation switch.

Ready-ON state is a state in which the voltage of the battery 21 of the battery pack 20 connected to the vehicle body 10 is applied to the circuit CR11 of the vehicle body 10. In Ready-ON state, SMR 13 is in the closed state, SMR 23 of the battery pack 20 is also in the closed state, and electric power is supplied from the battery 21 corresponding to the closed state SMR 23 to the vehicle driving device (MG 11a and inverter 11b). Ready-OFF state is a state in which the voltage of the battery 21 is not applied to the circuit CR11. In Ready-OFF state, SMR 13 is in the open state, and no electric power is supplied to the vehicle-driven device from the battery 21 of the battery pack 20.

The battery pack 20 mounted on the vehicle 100 can be replaced with another battery pack. FIG. 2 is a diagram illustrating an example of a configuration of a battery replacement system for replacing a battery pack. The battery replacement system 300 illustrated in FIG. 2 is mounted in, for example, a battery replacement station.

Referring to FIG. 2, the battery replacement system 300 is configured to remove a battery pack mounted on the vehicle 100 from the vehicle body 10 and attach another battery pack to the vehicle body 10.

Hereinafter, the battery pack collected from the vehicle 100 is referred to as a “battery pack B1”, and the battery pack attached to the vehicle 100 instead of the battery pack B1 is referred to as a “battery pack B2”. Each of the battery pack B1, B2 has the configuration of the battery pack shown in FIG. 1. The battery pack B2 after being attached to the vehicle body 10 functions as the battery pack 20 (FIG. 1) in the vehicle 100.

Specifically, the battery replacement system 300 includes a first storage device 310, a second storage device 320, a recovery device 330, a filling device 340, an replacement device 350, a server 380, and a display device 390. The first storage device 310 stores a plurality of battery packs to be supplied to the vehicle. The first storage device 310 includes a charger and a supply device in addition to a pack storage unit (for example, a storage). The second storage device 320 stores a plurality of battery packs collected from a plurality of vehicles. The second storage device 320 includes an inspection device and a sorting device in addition to a pack storage unit (for example, a storage box). The server 380 includes a processor, a storage device, and a communication device, and functions as a control device. The storage device stores information (e.g., specification information) related to the respective battery packs present in the battery replacement system 300 separately by the identification information (pack ID) of the battery packs. The display device 390 displays information in accordance with an instruction from the server 380.

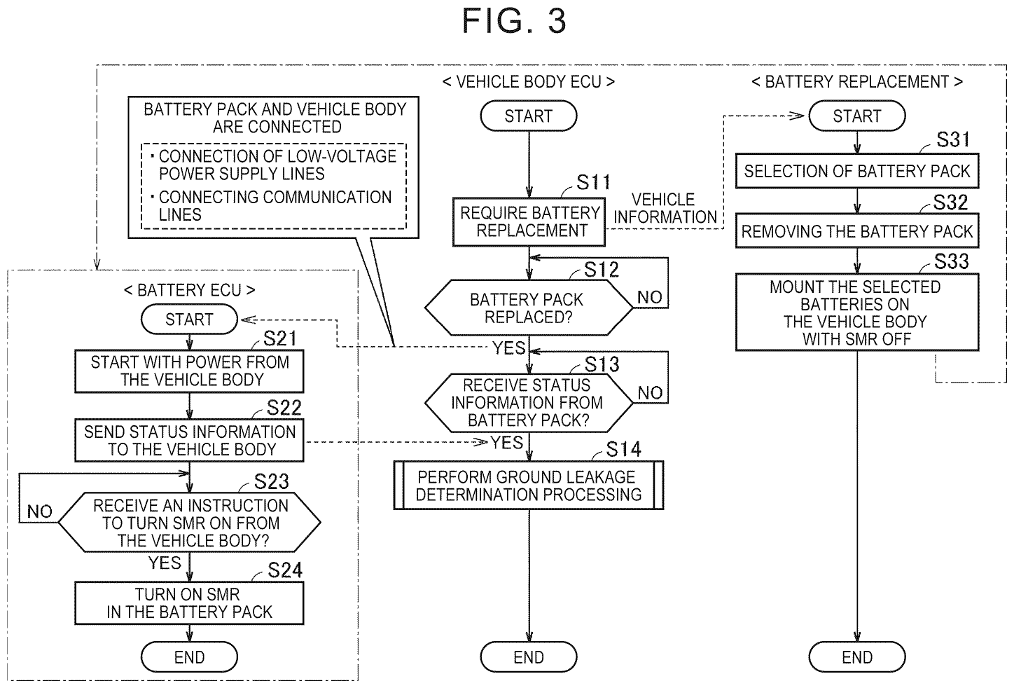

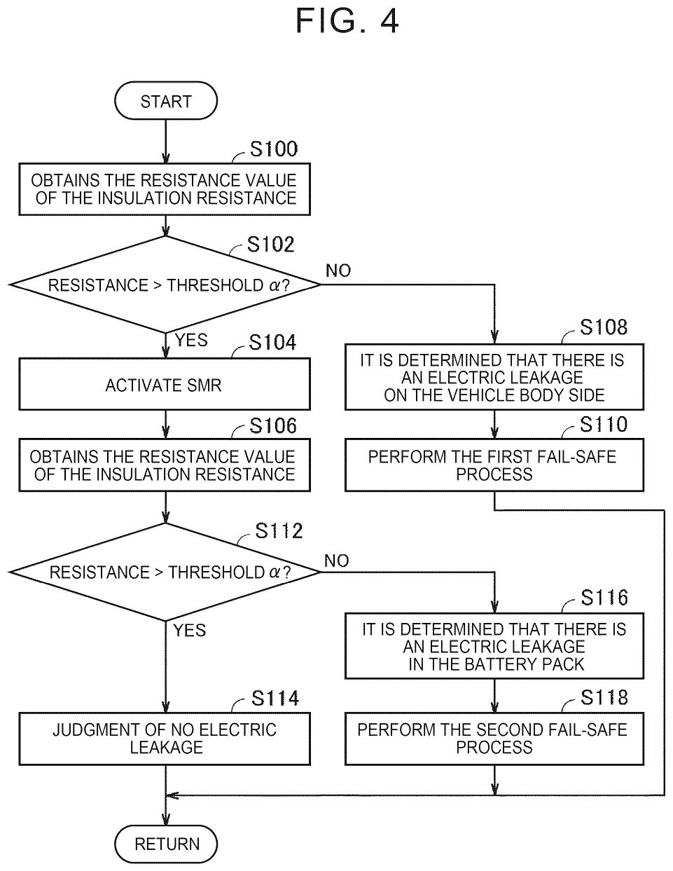

Hereinafter, a battery replacement method will be described with reference to FIGS. 1 to 4. FIG. 3 is a flowchart illustrating an example of a method of replacing a battery pack. FIG. 4 is a flowchart illustrating an example of the electric leakage determination process illustrated in FIG. 3. For example, after the vehicles 100 are parked in a predetermined area in the battery-replacing station, ECU 18a starts S14 process from S10 shown in FIG. 3. ECU 18a may initiate the process flow in response to a request from a terminal (user terminal) of the user of the vehicle 100 or a request from an inputting device in the vehicle 100. ECU 18a and the server 380 are configured to be wirelessly communicable.

In step (hereinafter, step is referred to as “S”) 11, ECU 18a transmits a signal requesting replacement of the battery pack (hereinafter, referred to as “replacement request signal”) to the server 380. The replacement request signal includes identification information (vehicle ID) of the vehicle 100 and specification information of the battery pack 20 (battery pack B1) mounted on the vehicle 100. The replacement request signal may include the specification information of the vehicle body 10 in place of or in addition to the specification information of the battery-pack B1.

In S12, ECU 18a determines whether or not the battery pack 20 has been replaced. The determination of S12 is repeated until the replacement of the battery-pack 20 is completed (NO in S12).

Upon receiving the exchange-request signal, the server 380 starts S33 process from S31 of FIG. 3.

In S31, the server 380 selects a battery pack that matches the specification of the vehicle 100 (the battery pack B1 or the specification of the vehicle body 10) indicated by the replacement request signal from among the battery packs (stocks) held by the first storage device 310. If it is determined that there is no battery pack in stock that matches the specifications of the vehicle 100, the server 380 may cause the display device 390 to display a message for explanation of the situation, and stop the battery replacement process. If S31 selects a battery pack, the process is transferred to S32.

In S32, the server 380 controls the replacement device 350 so that the battery-pack B1 is removed from the vehicle body 10. Accordingly, the vehicle body 10 and the battery-pack B1 are separated from each other. The process is then transferred to a S33.

In S33, the server 380 controls the charger of the first storage device 310 so that the battery-pack B2 selected by S31 is charged. However, the charging timing can be changed as appropriate. The charged battery pack may be filled in the first storage device 310. When the charging is completed, the server 380 controls the supply device of the first storage device 310 so that the battery-pack B2 is conveyed (supplied) from the first storage device 310 to the replacement device 350. Subsequently, the server 380 controls the replacement device 350 so that the battery-pack B2 is attached to the vehicle body 10. At this time, SMR 23 of the attached battery-pack B2 is opened. Thereafter, the server 380 transmits a signal indicating completion of the installation of the battery pack (hereinafter, referred to as a “replacement completion signal”) to ECU 18a.

FIG. 2 illustrates an example in which removal of the battery pack and attachment of the battery pack are performed at different positions. The vehicle position may be adjusted prior to removal of the battery pack, prior to installation of the battery pack, or both. A conveyance device (for example, a conveyance device of a conveyor type) or a conveyance robot (not shown) may move the vehicle. However, the removal of the battery pack and the attachment of the battery pack may be performed at the same position. The battery pack may be replaced (removed and attached) while the vehicle is stationary. The transport method of each of the recovery device 330, the supply device, and the filling device 340 is also arbitrary. These conveyance methods may be a conveyor method or a method using a conveyance robot. Note that the battery pack (power storage device) may be manually replaced by the user without communication between the battery replacement system (station) and the vehicle.

For example, when the battery pack B2 is attached to the vehicle body 10, the terminal T11, T12 of the battery pack B2 is connected to the terminal T21, T22 of the vehicle body 10. As a result, the vehicle body 10 and the battery pack B2 are connected to each other as shown in FIG. 1. By attaching the battery pack B2 to the vehicle body 10, a low-voltage power supply line (circuit CR12, CR22) and a communication line (communication line CL1, CL2) are connected between the vehicle body 10 and the battery pack B2. Then, in the battery-pack B2, S24 process is started from S21 shown in FIG. 3.

In S21, ECU 28a is activated by electric power supplied from a power source (auxiliary battery 17) in the vehicle body 10. The process is then transferred to a S22.

In S22, ECU 28a transmits information indicating the state of the battery pack (hereinafter, referred to as “state information”) to ECU 18a. The status information includes, for example, information about the present-day voltage of the battery 21 detected by BMS 22a. The voltage of the battery 21 may vary depending on SOC (State Of Charge of the battery 21). SOC represents, for example, a ratio of the present amount of stored electricity to the amount of stored electricity in a fully charged state, from 0 to 100%. The process is then transferred to a S23.

In S23, ECU 28a determines whether or not a SMR on-command has been received from the vehicle body 10. ECU 28a waits for a SMR on-command from the vehicle body 10 in S23 while keeping SMR 23 open. When ECU 28a receives SMR on-command (YES in S23), the process proceeds to S24.

In S24, ECU 28a switches SMR 23 from the open state (shut-off state) to the closed state (connected state).

On the other hand, when the battery-pack B2 is attached to the vehicle body 10, ECU 18a receives a replacement completion signal (S33) from the server 380. Accordingly, when it is determined that S12 is YES, the process proceeds to S13.

In S13, ECU 18a determines whether the status data is received from ECU 28a of the battery-pack B2. When ECU 18a receives the status information from the battery pack (YES in S13), the process is transferred to S14.

In S14, ECU 18a executes the electric leakage determination process. Hereinafter, the leakage determination process will be described with reference to the flowchart of FIG. 4.

In S100, ECU 18a acquires the resistance of the insulating resistance. For example, ECU 18a acquires the resistance of the insulating resistance from ECU 18d. The process is then transferred to a S102.

In S102, ECU 18a determines whether or not the resistance value of the insulating resistance obtained by S100 is larger than the threshold value α. The threshold value α is a predetermined value for determining the presence or absence of an electric leakage, and is adapted by an experiment or the like. When it is determined that the resistance value of the insulation resistance is larger than the threshold value α (YES in S102), the process proceeds to S104.

At S104, ECU 18a turns on SMR 13, 23. Specifically, ECU 18a transmits a SMR on command to each of SMR 13 and ECU 28a. The process is then transferred to a S106.

In S106, ECU 18a acquires the resistance of the insulating resistance. For example, ECU 18a acquires the resistance of the insulating resistance from ECU 18d. The process is then transferred to a S112. If it is determined in S102 that the resistance value of the insulating resistance is equal to or less than the threshold value α (NO in S102), the process proceeds to S108.

In S108, ECU 18a determines that there is an electric leakage in the vehicle body 10. For example, ECU 18a sets a flag indicating that there is an electric leakage in the vehicle body 10 to an on-state. The process is then transferred to a S110.

In S110, ECU 18a performs a first fail-safe process. The first fail-safe process may include at least one of a process of controlling SMR 13 to be in the off state, a process of prohibiting SMR 13 from being switched to the on state, a process of controlling SMR 23 to be in the off state, and a process of prohibiting SMR 23 from being switched to the on state. For example, ECU 18a may execute the first fail-safe process on the condition that a flag indicating that there is an electric leakage is on the vehicle body 10. The process is then terminated.

In S112, ECU 18a determines whether or not the resistance value of the insulating resistance obtained by S106 is larger than the threshold value α. Since the threshold value α is as described above, the detailed description thereof will not be repeated. When it is determined that the resistance value of the insulation resistance is larger than the threshold value α (YES in S112), the process proceeds to S114.

In S114, ECU 18a determines that there is no electric leakage. The process is then terminated. For example, ECU 18a sets a flag indicating that there is no electric leakage on both the vehicle body side and the battery pack side to the ON-state. ECU 18a may allow the transition to Ready-On condition provided that the flag indicating no leakage is in the on-state. If it is determined in S112 that the resistance value of the insulating resistance is equal to or less than the threshold value α (NO in S112), the process proceeds to S116.

In S116, ECU 18a determines that there is an electric leakage in the battery pack 20. ECU 18a sets, for example, a flag indicating that the battery pack 20 is in an on-state. The process is then transferred to a S118.

In S118, ECU 18a performs a second fail-safe process. The second fail-safe process may include, for example, at least one of a process of controlling SMR 13 to an off state, a process of prohibiting the switching of SMR 13 to an on state, a process of controlling SMR 23 to an off state, and a process of prohibiting the switching of SMR 23 to an on state. The second fail-safe process may be the same process as the first fail-safe process or may be a different process. For example, ECU 18a may execute the second fail-safe process on the condition that a flag indicating that there is an electric leakage is turned on in the battery pack 20. The process is then terminated.

As described above, according to the vehicle 100 of the present embodiment, it is possible to identify the cause of the electric leakage while detecting the presence or absence of the electric leakage by using the detection result of whether or not the resistance value of the insulation resistance in a state in which the battery pack 20 and the electric circuit on the vehicle body 10 side are connected is lower than the threshold value and the detection result of whether or not the resistance value of the insulation resistance in a state in which the battery pack 20 and the electric circuit on the vehicle body 10 side are disconnected is lower than the threshold value. Therefore, when an electric leakage is detected prior to turning on SMR 23 of the battery pack 20, it can be determined that the electric leakage is caused by the electric circuit of the vehicle body 10. Further, when it is determined that there is no electric leakage in the vehicle body 10 side and SMR 23 of the battery pack 20 is turned on and it is determined that there is an electric leakage, it is possible to specify that the cause of the electric leakage is caused by the battery pack 20 side. Therefore, it is possible to provide a vehicle that performs appropriate electric leakage detection in a vehicle equipped with a detachable battery.

Modification examples will be described below.

In the above-described embodiment, ECU 18a has been described as executing the first fail-safe process when it is determined that there is an electric leakage on the vehicle body 10 that the resistance value of the insulation resistance is equal to or less than the threshold value α when SMR 13, 23 is in the off-state. However, ECU 18a may notify the user of the occurrence of an electric leakage in the vehicle body 10 using an HMI 19a including a notification device instead of or in addition to executing the first fail-safe process. The notification method may be, for example, a method of displaying the occurrence of an electric leakage in the vehicle body 10 using image information or character information, or a method of notifying the occurrence of an electric leakage in the vehicle body 10 using sound or the like. ECU 18a may cause the display device 390 to display information indicating that an electric leakage has occurred in the vehicle body 10 via the server 380.

In this way, the user can recognize that the cause of the electric leakage is caused by the electric circuit on the vehicle body side.

Further, in the above-described embodiment, ECU 18a has been described as executing the second fail-safe process when SMR 13, 23 is in the off state and when it is determined that there is an electric leakage in the battery pack 20 that the resistance value of the insulation resistance is equal to or less than the threshold value α when SMR 13, 23 is in the on state. ECU 18a may notify the user of the occurrence of an electric leakage in the battery pack 20 using HMI 19a instead of or in addition to the execution of the second fail-safe process. HMI 19a includes a notification device. ECU 18a may cause the display device 390 to display information indicating that an electric leakage has occurred in the battery pack 20 via the server 380.

In this way, it is possible to allow the user to recognize that the cause of the electric leakage is caused by the battery pack 20.

Further, in the above-described embodiment, the case where one battery pack 20 is mounted on the vehicle 100 has been described as an example, but a plurality of battery packs 20 may be mounted on the vehicle 100. In this case, a SMR 23 for connecting and disconnecting the electric circuitry of the vehicle body 10 is provided in each of the plurality of battery-packs 20. ECU 18a changes the combination of the on-state and the off-state of SMR 23 in the plurality of battery packs 20 to detect the presence or absence of an electric leakage for each battery.

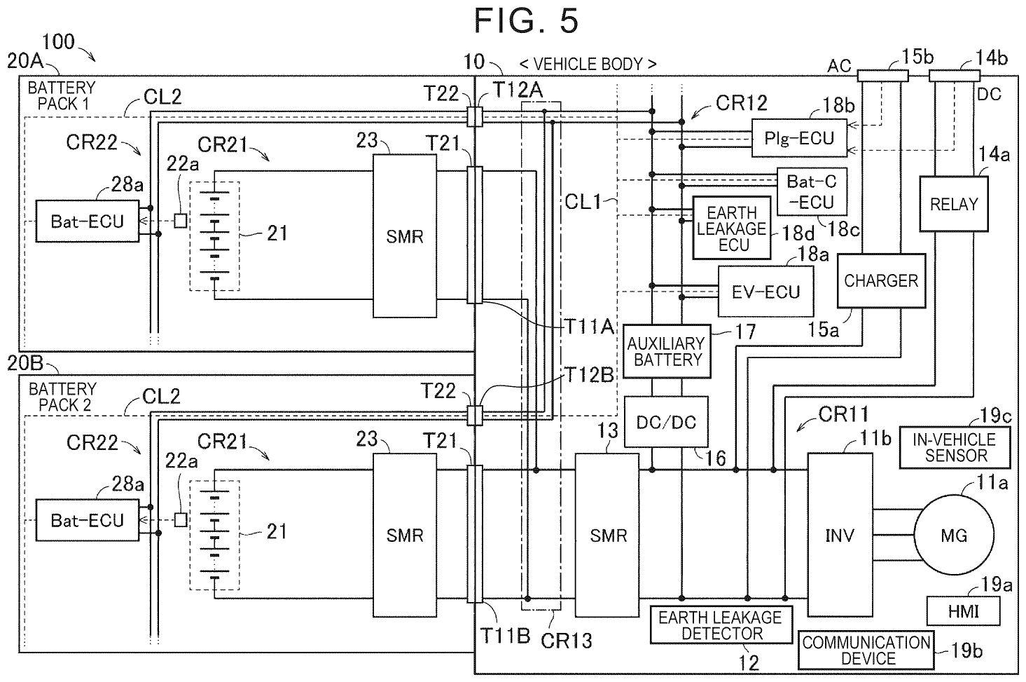

FIG. 5 is a diagram illustrating an example of a configuration of a vehicle 100 according to a modification. The vehicle 100 illustrated in FIG. 5 differs from the vehicle 100 illustrated in FIG. 1 in that the battery pack 20 includes a battery pack 20A, 20B and a parallel-circuit CR13 that connects the battery pack 20A, 20B to SMR 13 in parallel. The battery pack 20A, 20B has the same configuration as that of the battery pack 20. Therefore, the detailed description thereof will not be repeated.

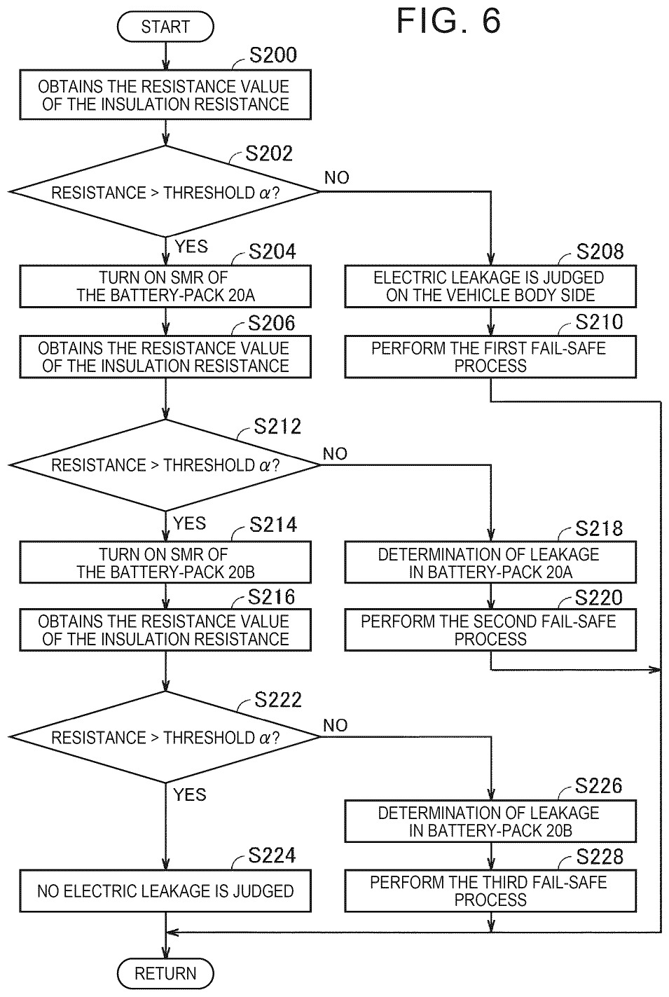

An example of the electric leakage determination process executed in the vehicle 100 will be described below. FIG. 6 is a flowchart illustrating an example of the electric leakage determination process according to the modification. The process illustrated in the flowchart of FIG. 6 is executed, for example, as a S14 leakage determination process in the flowchart of FIG. 3.

In S200, ECU 18a acquires the resistance of the insulating resistance from ECU 18d. The process is then transferred to a S202.

In S202, ECU 18a determines whether or not the resistance value of the insulating resistance obtained by S100 is larger than the threshold value α. When it is determined that the resistance value of the insulation resistance is larger than the threshold value α (YES in S202), the process proceeds to S204.

In S204, ECU 18a sets SMR 23 of the battery-pack 20A to the on-state. The process is then transferred to a S206.

In S206, ECU 18a acquires the resistance of the insulating resistance from ECU 18d. The process is then transferred to a S212. If it is determined that the resistance value of the insulating resistance acquired by S100 is equal to or less than the threshold value α (NO in S202), the process proceeds to S208.

In S208, ECU 18a determines that there is an electric leakage in the vehicle body 10. The process is then transferred to a S210.

In S210, ECU 18a performs a first fail-safe process. Since the first fail-safe process is as described above, the detailed description thereof will not be repeated. The process is then terminated.

In S212, ECU 18a determines whether or not the resistance value of the insulating resistance obtained by S206 is larger than the threshold value α. When it is determined that the resistance value of the insulation resistance is larger than the threshold value α (YES in S212), the process proceeds to S214.

In S214, ECU 18a sets SMR 23 of the battery-pack 20B to the on-state. The process is then transferred to a S216.

In S216, ECU 18a acquires the resistance of the insulating resistance from ECU 18d. The process is then transferred to a S222. If it is determined that the resistance value of the insulating resistance acquired by S212 is equal to or less than the threshold value α (NO in S212), the process proceeds to S218.

In S218, ECU 18a determines that there is an electric leakage in the battery-pack 20A. The process is then transferred to a S220.

In S220, ECU 18a performs a second fail-safe process. The second fail-safe process may include, for example, at least one of a process of controlling SMR 13 to the off state, a process of prohibiting the switching of SMR 13 to the on state, a process of controlling SMR 23 of the battery pack 20A to the off state, and a process of prohibiting the switching of SMR 23 of the battery pack 20A to the on state. The process is then terminated.

In S222, ECU 18a determines whether or not the resistance value of the insulating resistance obtained by S216 is larger than the threshold value α. When it is determined that the resistance value of the insulation resistance is larger than the threshold value α (YES in S222), the process proceeds to S224.

In S224, ECU 18a determines that there is no electric leakage. The process is then terminated. If it is determined that the resistance value of the insulating resistance acquired by S216 is equal to or less than the threshold value α (NO in S222), the process proceeds to S226.

In S226, ECU 18a determines that there is an electric leakage in the battery-pack 20B. The process is then transferred to a S228.

In S228, ECU 18a performs a third fail-safe process. The third fail-safe process may include, for example, at least one of a process of controlling SMR 13 to the off state, a process of prohibiting the switching of SMR 13 to the on state, a process of controlling SMR 23 of the battery pack 20B to the off state, and a process of prohibiting the switching of SMR 23 of the battery pack 20B to the on state. The process is then terminated.

In this way, in vehicles equipped with a plurality of battery packs (battery pack 20A, 20B), the presence or absence of an electric leakage is detected for each battery pack by changing the combination of the on-state and the off-state of SMR 13, 23. As a result, it is possible to accurately identify which battery pack is generating an electric leakage. The number of battery packs 20 mounted on the vehicle 100 is not limited to two, and three or more battery packs 20 may be mounted.

Note that, in this modification, when the resistance of the insulating resistance is larger than the threshold value α, SMR 23 of the battery pack 20B is set in the ON state while SMR 23 of the battery pack 20A is kept in the ON state. However, for example, after SMR 23 of the battery pack 20A is turned off, SMR 23 of the battery pack 20B may be turned on. Alternatively, the resistance value of the insulation resistance may be obtained by first turning on SMR 23 of the battery pack 20B to obtain the resistance value of the insulation resistance, and when the resistance value is larger than the threshold value α, SMR 23 of the battery pack 20A may be turned on to obtain the resistance value of the insulation resistance to detect the presence or absence of an electric leakage.

Further in the above embodiment has been described as an example when the execution subject of the electric leakage determination process including the switching of SMR 13, 23 is ECU 18a. However, the execution subject of the leakage determination process or the switching subject of SMR 13, 23 is not limited to ECU 18a. The execution subject of the leakage determination process or the switching subject of SMR 13, 23 may be, for example, an ECU 18d or another ECU mounted on the vehicle body 10.

Further, the configuration of the vehicle body 10 illustrated in FIG. 1 or FIG. 5 can be changed as appropriate. For example, SMR 13 of the vehicle body 10 may be omitted, or SMR 23 of the battery-pack 20, 20A, 20B may be omitted. In addition, at least one of DC inlet 14b and AC inlet 15b may be omitted, or may be changed to one inlet shared by AC/DC. These inlets may be configured to be capable of bidirectional power transfer. The vehicle body may perform an external power supply (V2X: Vehicle to Everything) using the electric power outputted from the attached battery pack.

All or some of the above-mentioned modified examples may be combined for implementation.

It should be considered that the embodiments disclosed above are for illustrative purposes only and are not limitative of the disclosure in any aspect. The scope of the disclosure is represented by the appended claims, not by the above description, and includes all modifications within the meanings and scope equivalent to the claims.

What is claimed is:

1. A vehicle comprising:
a vehicle body;
a battery detachable from the vehicle body; and
a detection device provided to an electric circuit on the vehicle body side and configured to detect whether an electric leakage has occurred, wherein the detection device is configured to detect whether the electric leakage has occurred in at least one of a conductive state in which the battery and the electric circuit are connected and a disconnected state in which the battery and the electric circuit are disconnected.

2. The vehicle according to claim 1, wherein the detection device is configured to detect whether the electric leakage of the electric circuit has occurred in the disconnected state and, when the electric leakage is not detected, detect whether the electric leakage has occurred in the conductive state.

3. The vehicle according to claim 1, wherein:
the vehicle body is configured such that a plurality of the batteries is mountable;
each of the batteries includes a relay configured to connect or disconnect the electric circuit; and
the detection device is configured to change a combination of an ON state and an OFF state of the relays of the batteries and detect whether the electric leakage has occurred in each of the batteries.

4. The vehicle according to claim 1, further comprising a notification device configured to give a notification about occurrence of the electric leakage in the vehicle body when the detection device has detected the electric leakage of the electric circuit in the disconnected state.

5. The vehicle according to claim 1, further comprising a notification device configured to give a notification about occurrence of the electric leakage in the battery when the detection device has not detected the electric leakage of the electric circuit in the disconnected state and has detected the electric leakage of the electric circuit in the conductive state.
